(19) United States
(12) Patent Application Publication
(10) Pub. No.: US 2002/0130841 A1
(43) Pub. Date: Sep. 19, 2002

(54) INPUT DEVICE FOR CONTROLLING A POINTER ON THE SCREEN OF A COMPUTER

(76) Inventor: JOHN DOUGLAS SCOTT, GALSON (AU)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 09/043,986

(22) PCT Filed: Feb. 12, 1997
(86) PCT No.: PCT/US97/02191

(30) Foreign Application Priority Data
Feb. 12, 1996 (AU) PN8022

(51) Int. Cl. G09G 5/08

(52) U.S. Cl. 345/166

(57) ABSTRACT

A hand operable input device (1) is coupled (2). The device (1) includes a housing (4) and an optical platen (5) supported by the housing (4) A sensing system (7) within the housing provides a signal indicative of a finger or other digit selectively engaged against the surface (6) of the platen (5). The signal is used to control a computer application. The signal may include positional information for controlling the operation of a pointer (2a) on the screen (2), and fingerprint information for authenticating the identity of the user to authorize use of an other application.

### BACKGROUND OF THE INVENTION

The present invention relates to a computer input device and in particular to an input device for controlling a pointer on the screen of a computer.

Most personal computers (PC's) include user input devices such as a keyboard and a mouse and/or a track ball. Such input devices allow a user to control a pointer on the computer screen. Use of the term “control” in reference to a pointer is defined herein as meaning either or both of:

1. Movement of the pointer between two points on a computer screen; or

2. Use of the pointer to actuate a particular piece of software to highlight, select or otherwise activate either a portion of the screen or other software.

For example, the pointer can be controlled by a track ball to move to a particular location on the computer screen and, once at that location, can be controlled by a button associated with the track ball or the keyboard to highlight an icon, press a button, choose a menu command or a portion of a toolbar, menu or the like.

A paramount concern with computer systems is security and authentication of a user's identity. This is not only important for a stand alone PC but also for PC's which are linked to other computer systems and users. There is a real need to prevent access by unauthorized users to data or software which is private, confidential and/or proprietary in nature.

Hitherto, security and authentication measures have included locating the computer in a secure location and only allowing predetermined authorized users to access that location. However, with the large scale interlinking of computers such a strategy is less effective. In any event, it is inconvenient and expensive to provide the secure location, particularly when access to the computer is required by a large number of users.

In an attempt to overcome these problems individual users have been issued passwords that permit them access to the computer system or to particular applications on the system. However, unscrupulous persons have been able to either directly or indirectly obtain passwords and subsequently gain unauthorized access to information and/or software.

### SUMMARY OF THE INVENTION

According to a first aspect of the invention, an input system for controlling a computer application includes a housing, a platen supported by the housing and including a surface against which a digit of a user is selectively engaged, a sensing system within the housing that provides a data signal indicative of the selective engagement of the digit on the platen, and means controlling the computer application based upon the data signal. The sensing system can be an optoelectronic sensing system, including a focusing lens structured and arranged to focus an image of the digit internally reflected from the surface against which the digit is engaged, and an image sensor structured and arranged to receive the focused image.

The invention can include various features alone or in combination. For example, the data signal may include data indicative of the identity of the user, wherein the application authenticates the user's identity based upon the data signal. The data indicative of the identity of the user includes data characteristic of fingerprint features of the selected digit. The application authorizes the operation of another application if the user's identity is authenticated. The sensing system can include a processor that authenticates the user's identity, the data signal including data indicative of the identity of the user resulting from the authentication. Alternatively, the data signal can be processed by the computer to authenticate the identity of the user. Authentication of the identity of the user can be done by comparing the signal with one or more predetermined samples to determine if a user is entitled to control the pointer. In some embodiments a negative authentication only prevents the operation of selected applications.

As used herein, the term “application” can include any function of a computer, such as, for example, general operation of the computer, any operation of a display pointer function, and any programmed function performed with the computer.

The data signal can additionally or alternatively include data indicative of the position of the digit on the platen surface. The application can be an application that positions a pointer at a location on a display screen that corresponds to the position of the digit on the platen surface. The application can instead be an application that moves a pointer on a display screen in a direction that corresponds to the position of the digit on the platen surface.

The data signal can include data responsive to an elapsed time of contact between the digit and the platen surface, wherein the application clicks on an other application selected by the position of the pointer if the elapsed time of contact is within a predetermined range.

In the embodiments wherein the controlled application involves using the pointer, the data signal can further include data indicative of the identity of the user, wherein the application authenticates the user's identity based upon the data signal, and wherein the application authorizes the operation another application if the user's identity is authenticated.

The input device can be configured with the platen being a button and the engagement effects depression of the button. The input device may be a keyboard including a track ball, the platen being positioned adjacent to the track ball.

The user can be selectively directed to effect engagement of the selected digit with the platen, and wherein the application includes authentication of the identity of the user.

The means controlling the application can include a processor configured to determine at least one of the group of features consisting of a duration of engagement between the digit and the platen, a location on the platen surface at which the digit is engaged with the platen, and the identity of the user. The processor can be located in one of the housing, the computer and an interface card disposed between the housing and the computer.

According to another aspect of the invention, an input device for a computer having a computer screen on which a pointer is displayed includes a housing and a platen supported by the housing and including a contact surface against which a user's digit is selectively engaged, and a sensing system within the housing that provides a data signal to the computer indicative of the position of the digit against the contact surface to allow the pointer to be displayed in a corresponding position on the screen. The sensing system can be an optoelectronic sensing system that includes a focusing lens that focuses an image of the digit internally reflected from a surface of the platen, and a sensor that provides a signal indicative of the internally reflected image in response thereto.

In one feature, the data signal can include data indicative of the fingerprint of the digit, wherein the data signal is provided to the computer to authenticate the user's identity, the desired display of the pointer only occurring if the authentication is positive.

In another feature, the sensing system can further include a processor that determines the authenticity of the user's identity based upon the signal indicative of the internally reflected image, wherein the data signal includes data indicative of the results of the determination.

The data signal can include data responsive to the timing of the engagement between the digit and the platen for controlling selection of an application with the pointer, wherein the data responsive to the timing of the engagement between the digit and the platen operates as a click of a standard mouse button.

The device can be a keyboard including a track ball, the platen being a button adjacent to the track ball.

According to yet another aspect of the invention, an input device for a computer having a computer screen on which a pointer is displayed includes a housing, a platen supported by the housing and including a contact surface against which a user's digit is selectively engaged to effect an actuation of the platen, and a sensing system for providing, upon actuation of the platen by the digit, a signal to the computer indicative of both actuation of the platen and the position of the digit against the contact surface to operate an application of the pointer.

According to yet another aspect of the invention, a computer input system for controlling a protected computer application on a computer includes an input device communicating with the computer, the input device having a housing and an optoelectronic system that provides an image signal indicative of features of engagement of a user's digit on an optical platen. The input system also includes processing means, including a processor, providing a control signal based upon the image signal to control the protected application. The input device can further include at least one mouse button.

The protected application can include at least one of the following applications: general use of the computer; use of another application on the computer; selection of another application with a pointer on a display screen; and positioning the pointer on the display screen.

The control signal can be based upon at least one of: a duration of engagement between the digit and the platen; a location on the platen at which the digit is engaged; fingerprint features of the digit; and the identity of the user.

The processor can be located in one of the housing, on an interface card disposed between the input device and the computer, and in the computer.

According to still another aspect of the invention, a method for controlling a computer application on a computer includes: providing an input device having an optical platen supported from a housing; selectively engaging a user's digit against a surface of the platen; providing an image signal indicative of the engagement of the digit on the platen surface; and controlling the computer application based upon the image signal.

Controlling the computer application can include determining at least one of: a duration of engagement between the digit and the platen; a location on the platen at which the digit is engaged; and the identity of the user. Controlling the computer application can also include at least one of: allowing general use of the computer; allowing use of an other application on the computer; selecting another application with a pointer on a display screen; and positioning the pointer on the display screen.

The method can further include selectively directing the user to effect engagement of a predetermined digit with the platen to enable authentication of the identity of that user.

According to yet another aspect of the invention, a method for controlling a pointer on a display screen of a computer includes: providing a platen which has a contact surface against which a user's digit is selectively engaged; providing an image signal indicative of the engagement of the digit on the contact surface; providing a pointer signal to the computer based upon the image signal, the pointer signal being indicative of the position of the digit against the contact surface; and positioning the pointer on the display screen in response to the pointer signal.

The positioning can include moving the pointer to a position on the display screen corresponding to the position of the digit on the contact surface. The positioning can instead include moving the pointer on the display screen in a direction corresponding to the position of the digit on the contact surface.

The method can include additional operations. For example, the method may include authenticating the user's identity based upon the image signal, and allowing the positioning of the pointer only if the authentication is positive. The method may further include determining a timing of the engagement between the digit and the platen, and selecting an application based upon the determined timing and the position of the pointer on the display screen.

The digit can be any of the user's fingers or thumb, such as, for example, the user's index finger.

The platen can be a button, wherein the engagement effects depression of the button. In some embodiments, depression of the button actuates the sensing system to provide the signal.

The platen includes a sheet of material which is transparent to a predetermined range of wavelengths of electromagnetic radiation, and the device includes a source mounted within the housing wherein the source emits electromagnetic radiation having a wavelength within the predetermined range, the radiation being directed through the platen and toward the digit being engaged therewith, the sensing system including a sensing array for generating the signal in response to electromagnetic radiation from the source which is reflected from the digit/platen interface.

The input device according to the invention contributes to the security of a computer system or of particular application on the computer by authenticating the identity of the user.

The input device also provides mouse functions for controlling the operation of a pointer on a computer display screen. For example, when the engagement of the user's digit on the platen is sensed, the sensing system Immediately relays this to the computer to effect actuation of a button on which the cursor is located or the like. In these embodiments the invention simulates a standard mouse button while also allowing the authentication of the user's identity due to the contact between the platen and the user's digit.

### BRIEF DESCRIPTION OF THE DRAWING

The invention will now be described, by way of examples only, with reference to the accompanying drawings in which:

FIG. 1 is a partial sectional side view of a device according to the invention;

FIG. 2 is a schematic view of a computer including the device of FIG. 1;

FIG. 3 is a top plan view of an alternative input device according to the invention, with a housing shown in outline to reveal interior components;

FIG. 4 is a side view of the device of FIG. 3, similarly shown with the housing in outline;

FIG. 5 is a schematic perspective view of a trackball according to the invention;

FIG. 6 is a schematic perspective view of a keyboard according to the invention; and

FIG. 7 is a schematic perspective view of an alternative keyboard according to the invention.

FIG. 8 is a schematic block diagram showing various optical and electrical components of an embodiment of the present invention.

### DESCRIPTION OF THE PREFERRED EMBODIMENTS

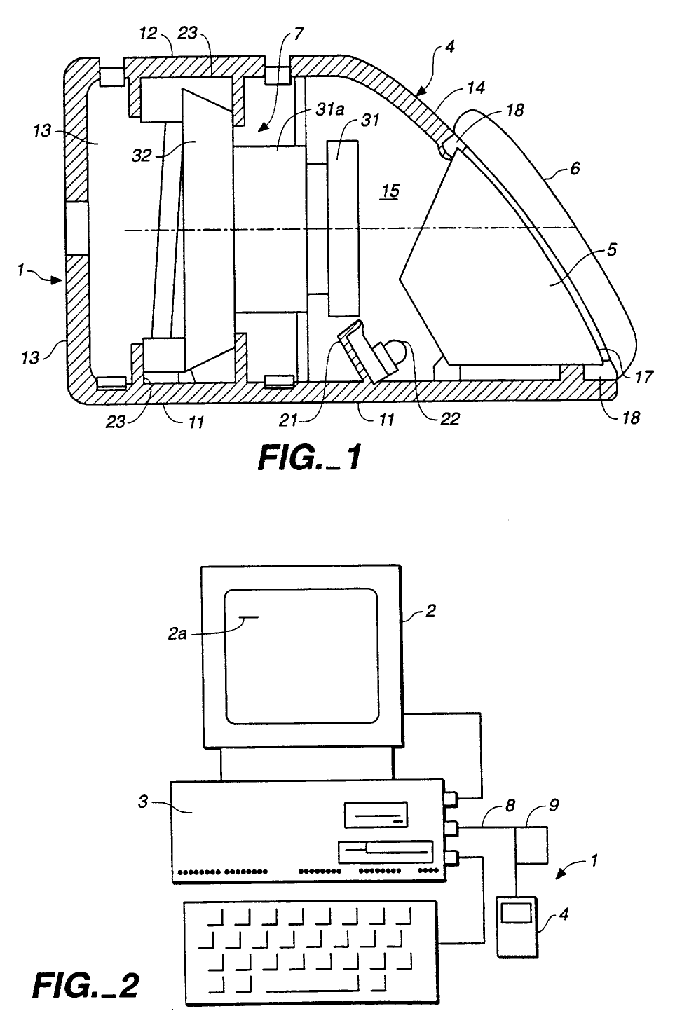

Referring to the FIG. 1 and FIG. 2, a hand operable input device 1 coupled to a computer 3 is used to obtain an image of a user's digit in contact with the device 1. The device produces a data signal in response to the image, and the data signal is used to control an application on the computer 3. The application may control the position of a pointer or cursor 2a on a display screen 2 of the computer 3, control selection of another application with the pointer or cursor 2a, or authenticate the user's identity for authorizing the user to use another application, such as using the computer 3 or using one or more other applications on the computer 3.

Device 1 includes a housing 4 and a platen 5 supported by housing 4. Platen 5 includes a surface 6 against which a user's digit can be selectively engaged. A sensing system 7 provides a signal indicative of the digit engaged against the surface 6. In the described embodiment, the sensing system includes an optical fingerprint image capture system, and the signal is indicative of fingerprint features of the digit and thereby is indicative of the identity of the user. The signal can also be indicative of the position of the digit on the surface 6, and of positive contact between the digit and the surface. The design of the optics and electronics of such systems is well known in the art of optoelectronic fingerprint imaging, therefore the sensing systems of the embodiments described herein will not be described in detail.

Housing 4 includes a spaced apart base 11 and top 12 which are substantially parallel and joined by upwardly extending rear and side walls 13, and front wall 14 to define a cavity 15. Front wall 14 is inclined with respect to base 11, while the other walls 13 are substantially perpendicular to base 11. Front wall 14 also includes an aperture over which the platen 5 is mounted. The platen 5 can be perspex or other transparent material which is snap locked to wall 14 by interaction between a groove 17 extending about the periphery of the platen and complementary catches 18 located about the adjacent periphery of the aperture.

Housing 4 also includes integrally molded mountings that support internal components of device 1. More particularly, a mounting 21 extends upwardly from and is inclined with respect to base 11. In the described embodiment, mounting 21 is substantially parallel to wall 14 such that a light source, such as an array of LEDs 22 supported by the mounting, are positioned to internally illuminate platen surface 6. LEDs 22 provide illumination in the visible spectrum, although other sources radiating other frequencies of electromagnetic radiation, for example infrared, may be used instead.

Sensing system 7 is captively retained in a second mounting 23 disposed within housing 4. Second mounting 23 includes ridges respectively extending upwardly from base 11 and downwardly from wall 12 that hold sensing system 7 in a fixed position relative to the platen 5.

Sensing system 7 includes a focusing lens 31 that is positioned to receive the light emitted from LEDs 22 which is internally reflected from the platen/digit interface at surface 6. Lens 31 provides a focused image of the internally reflected light. The reflected light includes an image of the fingerprint of the user's digit, which is made up of a pattern of ridges and valleys that lie across the surface of the user's digit.

Sensing system 7 also includes a visible light sensor 31a that receives the focused image and converts it to a digital signal indicative of the reflected image of the user's finger. Light sensor 31a is selected to be sensitive to the frequency of light emitted by the LED's. The digital signal is provided to a processor 32, which includes components such as a microprocessor, memory and a communication interface (all not shown). Processor 32 converts the digital signal to a data signal which is subsequently provided to computer 3 via cable 8 for further processing. As mentioned above, the data signal can include a data representation of the pattern of ridges and valleys that form the fingerprint of the digit, data indicative of the relative location of the fingerprint image on platen surface 6, data indicative of positive contact between the digit and the surface 6 or how long the digit has been engaged with the platen surface 6, as well as any other required detail.

In use, a user rests the palm of their hand on top 12. Once the presence of a digit against platen 5 is detected the processor 32 obtains the necessary details from the image provided by lens 31 and sensor 31a. This detail is conveyed, in the form of the data signal, to computer 3. The data signal includes sufficient information to identify the fingerprint and to locate its position on platen surface 6.

The signal is processed by the computer 3 to provide an authorization function to control access to one or more protected applications in the following manner. Computer 3 processes the fingerprint information contained within the data signal to allow comparison with stored details extracted from the fingerprints of authorized users of the protected applications. The method of image processing and comparison can be one of several known in the art, such as, for example, the method described in U.S. Pat. No. 5,067,162, to Driscoll, Jr. et al., the entire disclosure of which is included herein by reference. There is a positive authentication of the user if the fingerprint features in the data correspond with those of an authorized user. If the user is authorized, the computer then allows the user to use the protected applications.

In one embodiment, the protected application is general use of the computer. In another embodiment, the protected application is use of the input device to control operation of the pointer 2a on the screen 2, for example to move the pointer 2a in accordance with the positional information contained in the data signal or to use the pointer 2a to click on selected applications as with a mouse.

Alternatively, the authentication can be conducted by an interface card 9 that includes a processor disposed between device 1 and computer 3, or by processor 32 within housing. In the latter case, the processor 32 authenticates the identity of the user by comparing the image signal with pre-stored data. The results of the authentication are included in the data signal in place of or in addition to the information referred to above.

To move the pointer 2a on the screen 2, sensing system 7 continuously provides the data signal and computer 3 receives and processes this signal at regular intervals to determine the position of the user's digit on platen 5. The user selectively engages his digit, for example his index finger, with platen surface 6 to control the position of the pointer 2a on display screen 2. That is, to effect movement of the pointer 2a from one point to another the user engages his finger against platen surface 6 at a location which corresponds with the desired location of the pointer 2a on screen 2. The signal output from processor is indicative of the finger position. In response to the signal, the computer 3 causes the pointer 2a to move to the corresponding location on the display screen 2. Accordingly, the user is able to drag his finger across the platen to effect a corresponding drag of the cursor across the screen. An appropriate scaling ratio is used, given that the area of surface 6 is only a small fraction of the area of a typical computer display screen. In other embodiments, the roll of the digit on the platen in a particular direction is used to progress the pointer across the screen in a corresponding direction.

As mentioned above, the data signal can be used much like a mouse button to click on a selected application, which can be an icon or other function displayed on the screen 2, or the like, being pointed to by the pointer 2a. To click on the selected application, a user causes their digit to make momentary contact with the platen 5. In one embodiment, the data signal provided by the processor 32 includes data indicative of the elapsed time of contact between the digit and the platen. The computer 3, in response to the data signal, determines if the elapsed time of contact is within a predetermined range, and if it is within the predetermined range, clicks on the selected application on which the pointer 2a is located. In another embodiment, the processor determine if the elapsed time is within the predetermined range and, if so, the data signal causes the computer to click on the application.

The predetermined range can be a parameter set by the user. The elapsed time of contact may be determined, for example, by determining the elapsed time during which there is a minimum area of contact between the digit and the platen 5. If contact continues beyond a selected maximum time, the device will not click on the selected application, but instead will interpret the contact to be for the purpose of moving the pointer 2a. The mouse button feature can be combined with the authorization function so that the user will be able to click on a selected application only if authorized to do so.

In another embodiment, the position of the finger on platen surface 6 provides information as to the desired direction of movement of the pointer 2a on the screen 2. For example, the platen surface 6 may be divided into a plurality of direction zones, each being associated with a direction to move the pointer 2a. The signal provided by the processor 32 is then indicative of a selected direction zone against which the digit is engaged. The computer 3, in response to the signal, moves the pointer 2a in the direction corresponding to the selected direction zone. Thus, selectively engaging the finger with the platen effects a desired direction translation of the pointer 2a across the screen 2.

The position of the finger on platen 5 can be determined by finding the area of contact of the finger with platen 5 from the fingerprint information. The position of the center of the area of contact is then determined mathematically and used to effect movement of the cursor. Alternatively, one or more distinctive features of the fingerprint can be identified, and tracked, to effect corresponding movement of the cursor. It will be appreciated that the positional information can be derived from one or more predetermined portions of the image. Use can also be made of an adjustable threshold of contact to ensure that no movement of the cursor occurs during an absence of significant engagement between the finger and platen 5. The threshold can be based on time of contact, area of contact or both.

Device 1 also can include, as required, one or more standard buttons which are activated by the user depressing them with a digit.

In another embodiment, platen 5 is a button which is selectively depressed by a user to control the cursor. Depression of the button also actuates processor means 32 to produce a data signal from the image provided by sensor 31. It will be appreciated that unless the sensing system 7 moves with the movement of the platen 5, the lens 31 will only be able to focus the reflected image on the sensor at one position of the platen 5. Moreover, in these embodiments the relative position of the digit on the platen is not used, but rather, the movement of the cursor is controlled by a standard mouse positional ball and sensor arrangement.

In further embodiments, the data signal is only generated when requested by computer 3. For example, computer 3, at predetermined time intervals, displays a message on screen 2 instructing the user to place their finger against the platen 5 to authenticate the user's identity. Alternatively, or in combination, a positive authentication must be obtained by computer 3 before activating particular software, or allowing access to particular data.

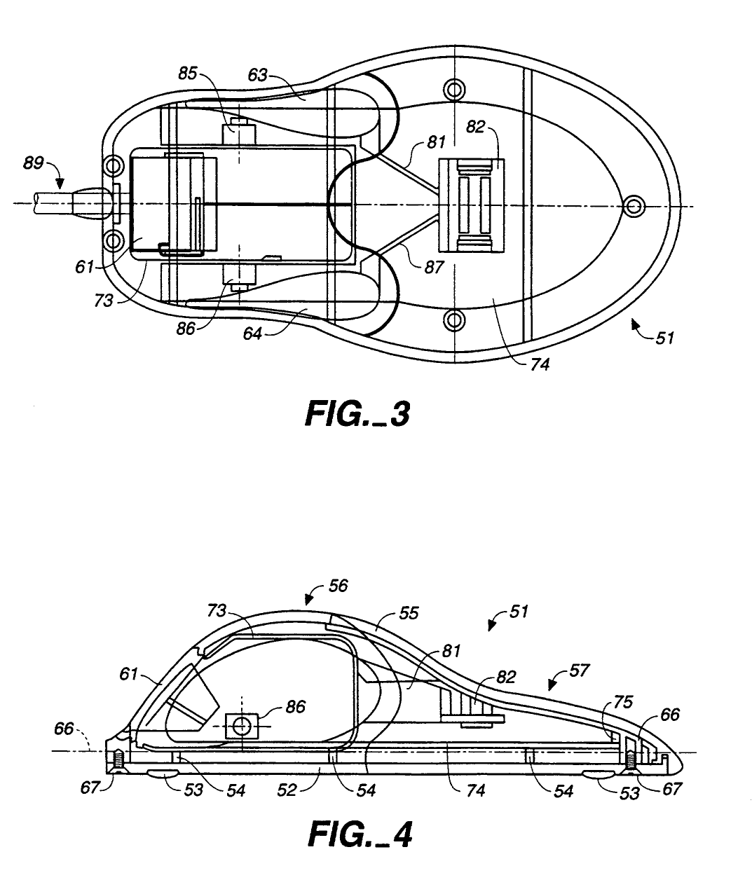

Reference is now made to FIGS. 3 and 4 which illustrate another embodiment of an input device 51 according to the invention. It will be understood that input device 51 can be used with the computer 3 shown in FIG. 1. The input device includes a planar longitudinally extending polycarbonate ABS alloy base 52, which has a plurality of spaced apart rubber feet 53 extending downwardly therefrom for engaging an adjacent planar surface on which device 51 is mounted. Base 52 also includes a plurality of longitudinally spaced apart transversely extending ribs 54. A contoured thermoplastic elastomer housing 55 extends upwardly from the periphery of base 52 to define a forward raised zone 56 and a rearwardly disposed lower zone 57. In FIGS. 3 and 4 housing 55 is shown in outline only to better illustrate the internals of device 51. Housing 55 includes a platen 61 which is centrally disposed at the front of zone 56 and configured for receiving into engagement therewith a user's index or middle finger. The housing also includes two buttons 63 and 64 which are located either side of and adjacent to platen 61. For right handed use, buttons 63 and 64 would be selectively engaged by a user's middle or ring finger and thumb respectively.

Base 52 and housing 55 are releasably secured together, for example, with removable fasteners or a clip latch. To this end, in the former case, housing 55 includes a plurality of threaded formations 66 for receiving screws 67 which extend through respective complementary apertures in base 52.

Within housing 55 there is a mounting 73 configured to hold an illumination source and a sensing system similar to corresponding components described above with reference to FIG. 1. These details have been omitted from this drawing to more clearly illustrate the internals of device 51. As with the sensing system 7 of input device 1, the sensing system of input device 51 includes a lens and processor (neither of which are shown) for obtaining the fingerprint information and providing this to the computer 3. Also included within housing 55 is a circuit board 74 which is fixedly retained within the housing 55 by the combination of ribs 54 extending upwardly from base 52 and formations 75 extending downwardly from housing 55. Board 74 is utilized in those embodiments of the invention where additional processing power is required within the device. For example, board 74 may be used where device 51 performs the authentication operation, rather than this being carried out by the associated computer, or a separate card within that computer.

Buttons 63 and 64 are standard mouse buttons. Each button includes an arm 81 which extends inwardly of housing 55 and which is resiliently mounted to a formation 82. Accordingly, after being depressed button 63, 64 will return to the non-depressed position under the resilient bias provided by arms 81 and formation 82. Each button is disposed adjacent a respective micro switch 85 and 86, which is actuated upon depression of the corresponding button 63, 64.

In use, the user rests their palm on zone 57 such that their fingers extend over zone 56. The user's index finger is then selectively engaged with platen 61 to effect control of the cursor on the screen of the associated computer. The data signal produced by the processor is provided to the computer by standard cabling 89 which extends from the front of device 51 to the computer. In this embodiment cabling 89 includes four pairs of twisted wire which connect directly into the mouse serial port of the associated computer.

The combination of platen 61, and buttons 63 and 64 provides for many alternative configurations. For example, buttons 63 and 64 can perform the standard right and left mouse buttons functions. Alternatively, if platen 61 is used as a left mouse button, either one of buttons 63 and 64 can be configured as the right mouse button, depending upon whether the user is left or right handed. Other configurations are also possible.

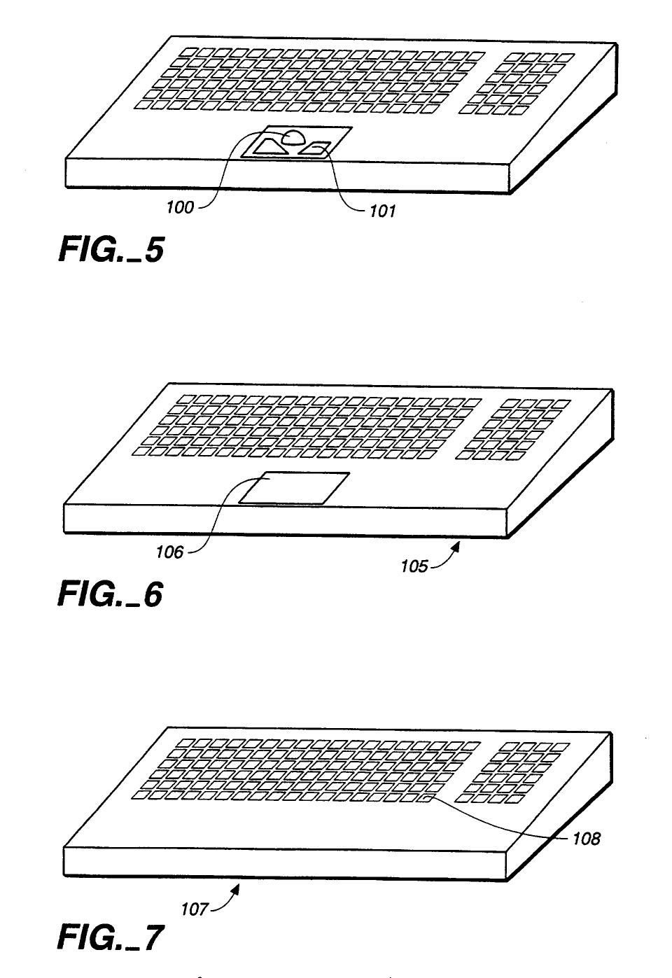

Reference is now made to FIG. 5, in which the invention is applied to a track ball 100. A platen 101 defines one of the buttons located adjacent the track ball 100. Accordingly, depressing the platen 101 actuates a sensing unit, such as, for example, one similar to the sensing unit described in reference to FIGS. 3-4, to provide a data signal to the associated computer to allow both authentication of the user's identity and control of the cursor.

Referring now to FIG. 6, a keyboard 105 constructed in accordance with the invention includes a fixed platen 106 against which a user selectively places a particular one of their digits, such as their index finger, to control the location of the cursor on the screen of a computer to which the keyboard 105 is connected. As described above, the information obtained from the engagement between the platen and the user's digit also allows the computer to authenticate the user, as required. An alternative keyboard 107, which is illustrated in FIG. 7, includes a key 108 which supports the platen. The key 108 can advantageously be the Enter or Return key.

An input device configured in accordance with the invention allows the secure configuration of a computer, whether that computer be a stand alone PC, a network or a mainframe. Appropriately configured software can authenticate the user, as required. For example, to log onto a computer a user may not only have to enter the correct password, but also place their index finger or thumb against an appropriate platen so that further authentication can be obtained.

The process of authenticating a user's identity can be performed many times during the normal use of the computer. Moreover, the information required for the authentication can be obtained without the user having to perform any operation they would not have otherwise undertaken.

If required, more than one platen can be provided to allow even more convenient operation of the input device.

The invention also facilitates secure financial transactions between a computer user and a vendor who is accessible by way of a computer network. For example, a user wishing to purchase goods and/or services from the vendor can enter their account details, along with details of the goods or services, and authenticate their identity by use of a device according to the invention. That is, the signal provided by the invention is appropriately encoded and conveyed from the user's computer to the vendor's computer where it is subsequently decoded. The vendor can then compare the signal with earlier obtained records, and if sufficient correlation is achieved, complete the transaction.

The invention has been developed primarily for use with a PC, however, it will be appreciated that the invention is not limited to that particular of use, but can also be used in conjunction with computer workstations, terminals within a computer network, over the internet, and in other configurations.

It will be appreciated that an input device according to the invention can be coupled to an associated computer or computer terminal via any of a variety of electrical and optical cabling arrangements, and may also communicate the data signal to the computer via a non-hard-wired arrangement.

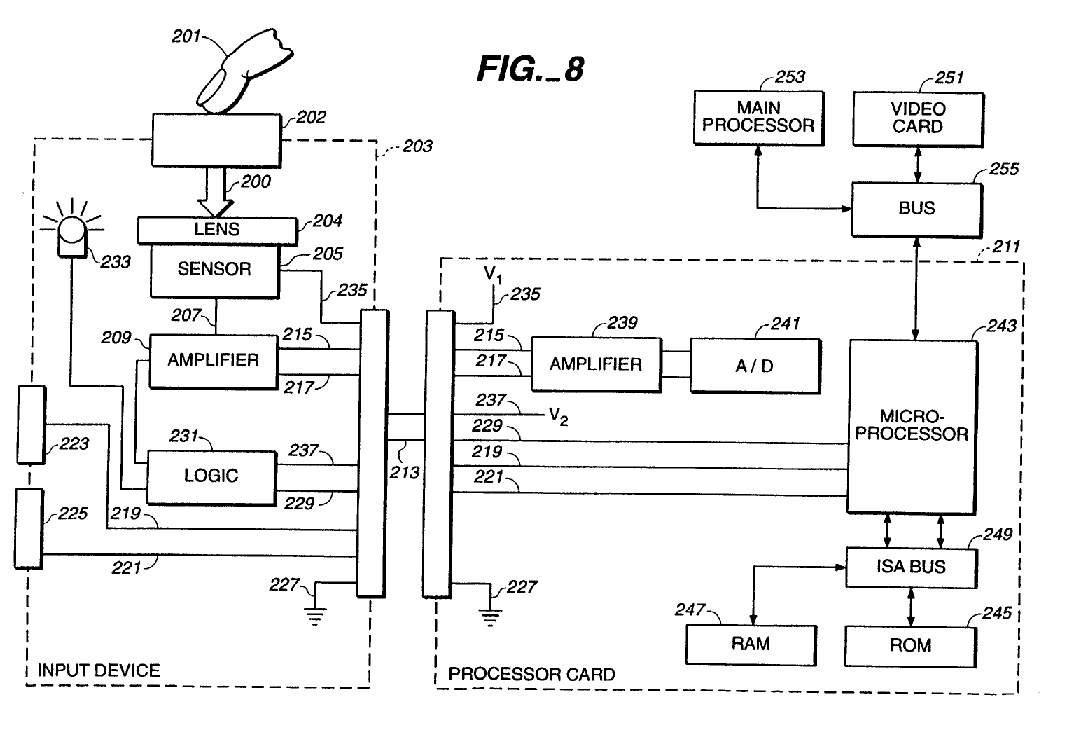

The arrangement of the electronic circuitry and certain optical components of an embodiment of the input system of the present invention is shown in FIG. 8. As shown, an image 200 of a finger 201 on a platen 202 of input device 203 is focused by lens 204 onto sensor 205. In response, sensor 205 produces an analog image signal 207 that is characteristic of the image 200. The sensor can be, for example, a CMOS video sensor available from Vision Limited of Scotland. Analog image signal 207 is input to an amplifier 209 with inverting and noninverting video outputs. The output of amplifier 209 is sent to a processor card 211, which can be located in a computer, a separate housing disposed between the computer and the input device, or in the input device itself. In the described embodiment, processor card 211 is located in the computer, and is coupled to the input device 203 by a cable 213 with four twisted pairs of wires. Two of the wires 215, 217, bring the video signal to the processor card 211 from the amplifier. Two other wires 219, 221 communicate signals from mouse buttons 223, 225, respectively. There is also a ground wire 227, a serial communication line 229 for communicating between the processor card 211 and a logic circuit 231 in input device 203. Logic circuit 231 controls functions such as the illumination from LEDs 233 and amplifier 209. There are also two power lines 235, 237 for powering the video sensor 205 and the logic circuit 231, respectively.

Processor card 211 includes a differential amplifier 239 that provides a signal to an analog-to-digital converter (A/D) 241 in response to the video signal from amplifier 209. The amplifier 239 includes inverting and noninverting video inputs. The A/D 241 converts the analog signal from amplifier 239 to a digital signal that is communicated to a microprocessor (μP) 243. The microprocessor 243 is coupled to a ROM 245 and a RAM 247 via ISA bus 249. Signals from mouse buttons 223, 225 are also coupled to microprocessor 243 via lines 219, 221, respectively. Communication line 229 is also coupled to microprocessor 243. Microprocessor 243 communicates with other computer components, such as a video card 251 and the computer's main processor 253 via another bus 255.

Although the invention has been described with reference to particular examples it will be appreciated, by those skilled in the art, that it may be embodied in many other forms.

What is claimed is:

1. An input system for controlling a computer application, the device including:
a housing;
a platen supported by the housing and including a surface against which a digit of a user is selectively engaged;
a sensing system within the housing that provides a data signal indicative of the selective engagement of the digit on the platen; and
means controlling the computer application based upon the data signal.

2. The input system of claim 1, wherein the sensing system is an optoelectronic sensing system, including a focusing lens structured and arranged to focus an image of the digit internally reflected from the surface against which the digit is engaged, and an image sensor structured and arranged to receive the focused image.

3. The input system of claim 2, wherein the data signal includes data indicative of the identity of the user, and wherein the application authenticates the user's identity based upon the data signal.

4. The input system of claim 3, wherein the data indicative of the identity of the user includes data characteristic of fingerprint features of the selected digit.

5. The input system of claim 3, wherein the application authorizes the operation of an other application if the user's identity is authenticated.

6. The input device of claim 5, wherein the sensing system includes a processor that authenticates the user's identity, wherein the data signal includes data indicative of the identity of the user resulting from the authentication.

7. The input system of claim 2, wherein the data signal includes data indicative of the position of the digit on the platen surface.

8. The input system of claim 7, wherein the application positions a pointer at a location on a display screen that corresponds to the position of the digit on the platen surface.

9. The input system of claim 8, wherein the data signal further includes data responsive to an elapsed time of contact between the digit and the platen surface, and wherein the application clicks on an other application selected by the position of the pointer if the elapsed time of contact is within a predetermined range.

10. The input system of claim 9, wherein the data signal further includes data indicative of the identity of the user, wherein the application authenticates the user's identity based upon the data signal, wherein the application authorizes the operation the other application if the user's identity is authenticated.

11. The input system of claim 7, wherein the application moves a pointer on a display screen in a direction that corresponds to the position of the digit on the platen surface.

12. The input system of claim 2, wherein the data signal includes data responsive to an elapsed time of contact between the digit and the platen surface.

13. The input system of claim 12, wherein the application clicks on another application if the elapsed time of contact is within a predetermined range.

14. The input system of claim 1, wherein the platen is a button and the engagement effects depression of the button.

15. The input system of claim 1, wherein the input device is a keyboard including a track ball, the platen being positioned adjacent to the track ball.

16. The input system of claim 1, wherein the user is selectively directed to effect engagement of the selected digit with the platen, and wherein the application includes authentication of the identity of the user.

17. The input system of claim 2, wherein the means controlling the application includes a processor configured to determine at least one of the group of features consisting of a duration of engagement between the digit and the platen, a location on the platen surface at which the digit is engaged with the platen, and the identity of the user.

18. The input system of claim 17, wherein the processor is located in one of the housing, the computer and an interface card disposed between the housing and the computer.

19. An input device for a computer having a computer screen on which a pointer is displayed, the device including:
a housing;
a platen supported by the housing and including a contact surface against which a user's digit is selectively engaged; and
a sensing system within the housing that provides a data signal to the computer indicative of the position of the digit against the contact surface to allow the pointer to be displayed in a corresponding position on the screen.

20. The input device of claim 19, wherein the sensing system is an optoelectronic sensing system that includes a focusing lens that focuses an image of the digit internally reflected from a surface of the platen, and a sensor that provides a signal indicative of the internally reflected image in response thereto.

21. The input device of claim 20, wherein the data signal includes data indicative of the fingerprint of the digit.

22. The input device of claim 21, wherein the data signal is provided to the computer to authenticate the user's identity, the desired display of the pointer only occurring if the authentication is positive.

23. The input device of claim 20, wherein the sensing system further includes a processor that determines the authenticity of the user's identity based upon the signal indicative of the internally reflected image, and wherein the data signal includes data indicative of the results of the determination.

24. The input device of claim 19 wherein the data signal includes data responsive to the timing of the engagement between the digit and the platen for controlling selection of an application with the pointer.

25. The input device of claim 24, wherein the data responsive to the timing of the engagement between the digit and the platen operates as a click of a standard mouse button.

26. The input device of claim 24, wherein the device is a keyboard including a track ball, the platen being a button adjacent to the track ball.

27. An input device for a computer having a computer screen on which a pointer is displayed, the device including:
a housing;
a platen supported by the housing and including a contact surface against which a user's digit is selectively engaged to effect an actuation of the platen; and
a sensing system for providing, upon actuation of the platen by the digit, a signal to the computer indicative of both actuation of the platen and the position of the digit against the contact surface to operate an application of the pointer.

28. A computer input system for controlling a protected computer application on a computer, comprising:
an input device communicating with the computer, including a housing, an optoelectronic system that provides an image signal indicative of features of engagement of a user's digit on an optical platen; and
processing means, including a processor, providing a control signal based upon the image signal to control the protected application.

29. The input system of claim 28, wherein the protected application includes at least one of:
general use of the computer;
use of an other application on the computer;
selection of an other application with a pointer on a display screen; and
positioning the pointer on the display screen.

30. The input system of claim 28, wherein the control signal is based upon at least one:
a duration of engagement between the digit and the platen;
a location on the platen at which the digit is engaged; and
fingerprint features of the digit.

31. The input system of claim 30, wherein the processor is located in one of the housing, on an interface card disposed between the input device and the computer, and in the computer.

32. The input system of claim 28, wherein the input device further includes at least one mouse button.

33. A method for controlling a computer application on a computer, the method comprising:
providing an input device having an optical platen supported from a housing;
selectively engaging a user's digit against a surface of the platen;
providing an image signal indicative of the engagement of the digit on the platen surface;
controlling the computer application based upon the image signal.

34. The method of claim 33, wherein controlling the computer application includes determining at least one of:
a duration of engagement between the digit and the platen;
a location on the platen at which the digit is engaged; and
the identity of the user.

35. The method of claim 34, wherein controlling the computer application includes at least one of:
allowing general use of the computer;
allowing use of an other application on the computer;
selecting an other application with a pointer on a display screen; and
positioning the pointer on the display screen.

36. The method of claim 35, further comprising selectively directing the user to effect engagement of a predetermined digit with the platen to enable authentication of the identity of that user.

37. A method for controlling a pointer on a display screen of a computer, the method including:
providing a platen which includes a contact surface against which a user's digit is selectively engaged;
providing an image signal indicative of the engagement of the digit on the contact surface;
providing a pointer signal to the computer based upon the image signal, the pointer signal being indicative of the position of the digit against the contact surface; and
positioning the pointer on the display screen in response to the pointer signal.

38. The method of claim 37, wherein the positioning includes moving the pointer to a position on the display screen corresponding to the position of the digit on the contact surface.

39. The method of claim 37, wherein the positioning includes moving the pointer on the display screen in a direction corresponding to the position of the digit on the contact surface.

40. The method of claim 37, further including authenticating the user's identity based upon the image signal, and allowing the positioning of the pointer only if the authentication is positive.

41. The method of claim 37, further including determining a timing of the engagement between the digit and the platen, and selecting an application based upon the determined timing and the position of the pointer on the display screen.
